(19) United States
(12) Patent Application Publication
(10) Pub. No.: US 2025/0348711 A1
(43) Pub. Date: Nov. 13, 2025

(54) DILATED CONVOLUTION AND ATTENTION-BASED NEURAL NETWORK WITH LINEAR COMPLEXITY

(71) Applicant: International Business Machines Corporation, Armonk, NY (US)

(72) Inventors: Aleksandar Terzic, Dietikon (CH); Michael Andreas Hersche, Zurich (CH); Kumudu Geethan Karunaratne, Zurich (CH); Abu Sebastian, Adliswil (CH); Abbas Rahimi, Rüschlikon (CH)

(21) Appl. No.: 18/660,448

(22) Filed: May 10, 2024

(51) Int. Cl. G06N 3/0464

(52) U.S. Cl. CPC G06N 3/0464

(57) ABSTRACT

Examples described herein provide a computer-implemented method that includes receiving, at a dilated convolution and attention-based neural network, vector embeddings corresponding to sequence elements of sequential data. The dilated convolution and attention-based neural network includes a dilated convolutional neural network, a plurality of block-local attention blocks, and a feed-forward neural network. The method further includes generating, using the dilated convolution and attention-based neural network, a sequence of vector embeddings based at least in part on the sequential data.

### STATEMENT REGARDING PRIOR DISCLOSURES BY THE INVENTOR OR A JOINT INVENTOR

The following disclosure is submitted under 35 U.S.C. 102(b)(1)(A):

DISCLOSURE(S): “TCNCA: Temporal Convolution Network with Chunked Attention for Scalable Sequence Processing,” Aleksandar Terzic, Michael Hersche, Geethan Karunaratne, Luca Benini, Abu Sebastian, Abbas Rahimi, Dec. 9, 2023, pages 1-12.

### BACKGROUND

The present disclosure relates to computing systems, and more specifically, to a dilated convolution and attention-based neural network with linear complexity.

Sequence modeling is a machine learning technique used to analyze and predict sequences of data. Sequence modeling provides for understanding patterns and relationships within sequential data, where the order of elements matters. Examples of sequential data include, but are not limited to, text streams, audio clips, video clips, time-series data, and/or the like. Sequence modeling can be used to perform speech recognition (e.g., generate a text transcript given an audio clip as input), sentiment classification (e.g., categorize opinions expressed in a piece of text), video activity recognition (e.g., identify an activity in a video clip), and/or the like.

Types of sequence models include, for example, recurrent neural networks (RNNs), long short-term memory (LSTM) networks, gated recurrent units (GRUs), transformer models, and/or the like. Sequence modeling involves training these models on labeled sequences of data to learn the underlying patterns and relationships within the sequences. Once trained, these models can be used for various tasks, such as sequence generation, sequence classification, sequence-to-sequence translation, and/or the like.

### SUMMARY

In one embodiment, a method is provided. The method includes receiving, at a dilated convolution and attention-based neural network, vector embeddings corresponding to sequence elements of sequential data. The dilated convolution and attention-based neural network includes a dilated convolutional neural network, a plurality of block-local attention blocks, and a feed-forward neural network. The method further includes generating, using the dilated convolution and attention-based neural network, a sequence of vector embeddings based at least in part on the sequential data.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIG. 2 illustrates a block diagram of components of a machine learning training and inference system, according to an embodiment;

FIG. 3 illustrates a block diagram of a dilated convolution and attention-based neural network, according to an embodiment;

FIG. 4 illustrates a block diagram of a dilated convolutional neural network, according to an embodiment;

FIGS. 5A and 5B illustrate aspects of a dilated convolutional neural network, according to an embodiment;

FIG. 6 illustrates an example of a network connectivity layout of a dilated convolutional neural network, according to an embodiment;

FIG. 7 depicts network connectivity for block-local attention blocks of a dilated convolution and attention-based neural network, according to one or more embodiments;

FIG. 8 illustrates a table of results of using a dilated convolution and attention-based neural network, according to one or more embodiments; and

FIG. 9 illustrates a flow diagram of a method for generating a sequence of vector embeddings based on sequential data using a dilated convolution and attention-based neural network, according to an embodiment.

The detailed description explains embodiments of the disclosure, together with advantages and features, by way of example with reference to the drawings.

### DETAILED DESCRIPTION

Sequence modeling is a machine learning technique used to analyze and predict sequences of data. Sequence models can utilize a transformer architecture (also referred to simply as a “transformer”) to process sequences of data. A transformer's compute and memory requirements are quadratic in the sequence length, which hinders the transformer's efficiency on longer sequences of data. Although efforts have been undertaken to improve transformer's efficiency on longer sequences of data (e.g., the introduction of efficient state-space models with sub-quadratic complexity), such approaches suffer in terms of quality of outputs.

Model efficiency can be expressed using “Big-O” notation. Big-O notation is a simple way of denoting how many operations an algorithm needs to execute in order to compute its output, measured in terms of the size of the input. Quadratic complexity algorithms (denoted “O(N²)”), as experienced by most sequence models, are typically computationally heavy and are restricted to relatively short inputs. Log-linear complexity (denoted “O(N*log N)”) algorithms and linear complexity algorithms (denoted “O(N)”) are typically not restricted to such relatively short inputs and are more suitable for relatively longer inputs.

The transformers are now described in more detail. The transformer is a highly successful deep neural network for handling sequential data. The transformer has found application in a range of data modalities such as audio, images, and text. Perhaps most notably, the transformer is the driving force behind the generative pre-trained transformer (GPT) model family, which is used to provide ChatGPT. Essentially, the transformer transforms an input sequence of vectors into an equal-length output sequence of vectors. Each element of the output depends on all elements of the input. Depending on the task at hand, further processing is applied to the output sequence. The input to a transformer is a sequence element, which can be words in a text, pixels in an image, etc. The inputs are fed through an embedding layer, which transforms the input sequence to vectors of real numbers, which can be manipulated mathematically. A self-attention module receives the vectors of real numbers. The self-attention module is a quadrat complexity operator that calculates the interactions between the pairs of input embeddings. There are N² such interactions, and thus the self-attention module has a O(N²) cost. The self-attention module outputs a sequence of vector embeddings, which are fed into a feed-forward neural network with a linear complexity (and thus a cost of O(N)). The feed-forward neural network applies a transformation on each sequence element independently and outputs a sequence of vector embeddings. The combination of self-attention module and the feed-forward neural network can iterate multiple times. That is, the sequence of vector embeddings from the feed-forward neural network can be fed back into the self-attention module cyclically.

While the transformer is a powerful model, it suffers from quadratic computational complexity (e.g., O(N²)), which restricts how long of a sequence length the transformer can efficiently operate. Particularly, the self-attention module causes the quadratic computational complexity (e.g., O(N²)); the computational cost scales quadratically in the input length. Consider the following situation for a sequence of four d-dimensional vector embeddings {u⁽¹⁾, . . . , u⁽⁴⁾}. The self-attention module takes the form of a quadratic attention matrix with four rows and four columns (for the four d-dimensional vector embeddings {u⁽¹⁾, . . . , u⁽⁴⁾}). The four columns of the first row of the quadratic attention matrix are as follows: u⁽¹⁾*u⁽¹⁾, u⁽¹⁾*u⁽²⁾, u⁽¹⁾*u⁽³⁾, and u⁽¹⁾*u⁽⁴⁾. The four columns of the second row of the quadratic attention matrix are as follows: u⁽²⁾*u⁽¹⁾, u⁽²⁾*u⁽²⁾, u⁽²⁾*u⁽³⁾, and u⁽²⁾*u⁽⁴⁾. The four columns of the third and fourth rows follow accordingly (e.g., u⁽³⁾*u⁽¹⁾, u⁽³⁾*u⁽²⁾, u⁽³⁾*u⁽³⁾, and u⁽³⁾*u⁽⁴⁾ for the third column; and u⁽⁴⁾*u⁽¹⁾, u⁽⁴⁾*u⁽²⁾, u⁽⁴⁾*u⁽³⁾, and u⁽⁴⁾*u⁽⁴⁾ for the fourth column). Thus, the self-attention module causes the quadratic computational complexity (O(N²) cost) due to the quadratic attention matrix that is implemented. The quadratic attention matrix generates an output sequence of vector embeddings. Each vector in the output sequence is computed as a weighted sum of the input sequence embeddings. For example, the vector (y⁽¹⁾) for the first row of the quadratic attention matrix is as follows (with similar vectors for the second, third, and four rows):

$${y}^{( 1 )} = {\sum }_{i = 1}^{4} {u}^{( 1 )} \cdot {u}^{( i )} ) * {u}^{( i )} . \qquad ( 1 )$$

An alternative approach to sequence modeling using transformers is to use state-space machines for sequence modeling. State-space models offer computationally more efficient ways of processing long sequences as compared to transformers. More particularly, compared to the transformer's quadratic complexity (O(N²)), state-space models operate with log-linear complexity (O(N*log N). Instead of the quadratic attention matrix present in the transformer-based approach, state-space models modify the input sequence by implementing a linear state-space layer. Given an input sequence {u⁽¹⁾, . . . , u^{(N)}}, state-space models compute the output sequence {y⁽¹⁾, . . . , y^{(N)}} using the following model:

$${x}^{( k + 1 )} = A {x}^{( k )} + B {u}^{( k )}$$

$${y}^{( k + 1 )} = C {x}^{( k + 1 )} ,$$

where x^{k} is a hidden state at time k and u^{k} is an input at time k.

Graphics processing units (GPUs) can be used as hardware accelerators for data-parallel computations, which are omnipresent in deep neural networks. The above model, however, is not data-parallel, and therefore cannot take advantage of GPUs as hardware accelerators. To exploit GPUs for fast training, the above recursive formula can be reformulated as a convolution as follows:

$${y}^{( k )} = {\sum }_{i = 1}^{k} {CA}^{k - i} {Bu}^{( i + 1 )} .$$

This convolution can now be efficiently evaluated using the convolutional theorem and fast Fourier transform approach, the computational cost of which is log-linear complexity (O(N*log N).

It has been proposed to fully replace the self-attention module of the transformer with a state-space model (also referred to as a “linear state-space model”). By running the state-space model in both directions over the input sequence, each element of the output depends on all elements of the input, which is an advantageous property of transformers. The computational bottleneck is now a log-linear complexity (O(N*log N), a significant reduction from the transformer's quadratic complexity (O(N²)). In this approach, the linear state-space module (which replaces the self-attention module of the transformer) outputs a sequence of vector embeddings (like the self-attention module of the transformer), which are fed into the feed-forward neural network having a linear complexity (and thus a cost of O(N)). The feed-forward neural network applies a transformation on each sequence element independently and outputs a sequence of vector embeddings. The combination of the state-space model and the feed-forward neural network can iterate multiple times. That is, the sequence of vector embeddings from the feed-forward neural network can be fed back into the state-space model cyclically.

Another approach to sequence modeling is referred to as a moving-average equipped gated attention (MEGA) approach. The MEGA approach implements a state-space layer that operates over the entire input sequence followed by attention that operates on fixed-size chunks of the sequence. The particular state-space layer that is proposed in the MEGA approach is denoted as an exponential moving average (EMA) layer. Rather than applying attention to the entire sequence, MEGA applies it to blocks of fixed length. In MEGA, no matter how long the input sequence is, each attention block only operates on a fixed number sequence elements, resulting in constant O(1) cost per block. The number of blocks, however, is proportional to N. As such, the total cost of the attention layer is O(N).

In the MEGA approach, the input (e.g., sequential data) is fed through an embedding layer, and resulting vector embeddings are input into a MEGA block. The MEGA block includes an EMA layer that receives each of the vector embeddings and generates EMA-modified sequences of vectors. The EMA-modified sequences of vectors are fed into attention blocks. Each attention block operates on a fixed-size sequence and thus has a cost of O(1) per block. However, the number of such blocks is proportional to N, so the total cost of this layer is O(N)*O(I)=O(N). In an example with six d-dimensional vector embeddings, the MEGA block includes three attention blocks; however, other numbers of vector embeddings and/or attention blocks can be implemented. The output of the attention blocks is fed into the feed-forward neural network having a cost of O(N), and the feed-forward neural network generates a sequence of vectors as output, such as described regarding the transformer architecture.

Although these approaches (namely using a self-attention module or a state-space model) are useful for sequence modeling, such approaches remain computationally expensive, especially for relatively long input sequences. Although computationally more efficient than using a self-attention module or a state-space model, the MEGA approach may not provide accurate results or efficient processing in some cases, such as on long-range-arena classification tasks, which are very long sequences ranging from 1K to 16K tokens, for example.

One or more embodiments described herein address these and other shortcomings by providing a dilated convolution and attention-based neural network architecture with linear complexity.

Dilated convolutions (also referred to as “dilated convolutional networks”) provide an alternative sub-quadratic complexity computational block for sequence modeling. Dilated convolutional networks are neural networks that capture long-range dependencies in input data in linear (O(N)) complexity. Dilated convolutional networks have been used for generating audio waveforms, to perform machine translation, and to process time-series data, for example.

Dilated convolutional networks are similar to convolutional neural networks (CNNs). The difference between dilated convolutional networks and CNNs lies in the fact that dilated convolutional networks exhibit larger receptive field sizes, which is a result of the way the convolutional kernel is applied. In CNNs, convolutions slide a kernel of fixed size over the input and compute the dot product between the kernel and the corresponding patch of the input at each position. Dilated convolutional networks also slide a kernel of fixed size over the input and compute the dot product between the kernel and the corresponding patch of the input; however, dilated convolutional networks “spread out” the kernel over the input. For example, in a CNN, a kernel of fixed size 3×3 corresponds to a 3×3 patch of the input. However, in dilated convolutional networks, the input patch is expanded, such as to 5×5 with certain of the input blocks being ignored such that only nine input blocks are used. The inner product is computed between the non-ignored blocks of the kernel and the corresponding non-ignored blocks in the input data. As an example, in the case of a 5×5 input patch, for the first, third, and fifth rows of the patch, only blocks one, three, and five are used while blocks two and four are ignored; each block of rows two and four are ignored, resulting in nine input blocks corresponding to the dilated convolution kernel.

A dilated convolution of a one-dimensional sequence of length N (x∈ [symbol] ^{N}) with a kernel of size K (h∈ [symbol] ^{K}, assume K is odd), and dilation f∈ [symbol] results in an output sequence y∈ [symbol] ^{N-f×(k-1)}, where each element of the output (yᵢ∈ [symbol] ) is expressed as:

$${y}_{i} = {\sum }_{k = 1}^{K} {h}_{k} \times {x}_{i + ( k - \frac{K - 1}{2} ) \times f}$$

where hₖ is the convolution kernel at position k and x^{k} is the input at time k. The input sequence can be padded in order for the output to be of the same length as the input. In some situations, such as where network connectivity is the primary focus, certain details can be abstracted away to represent the dilated convolutions in a simplified way, where the dilation f is the distance between two consecutive elements picked up by the convolution kernel (e.g., f=2).

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

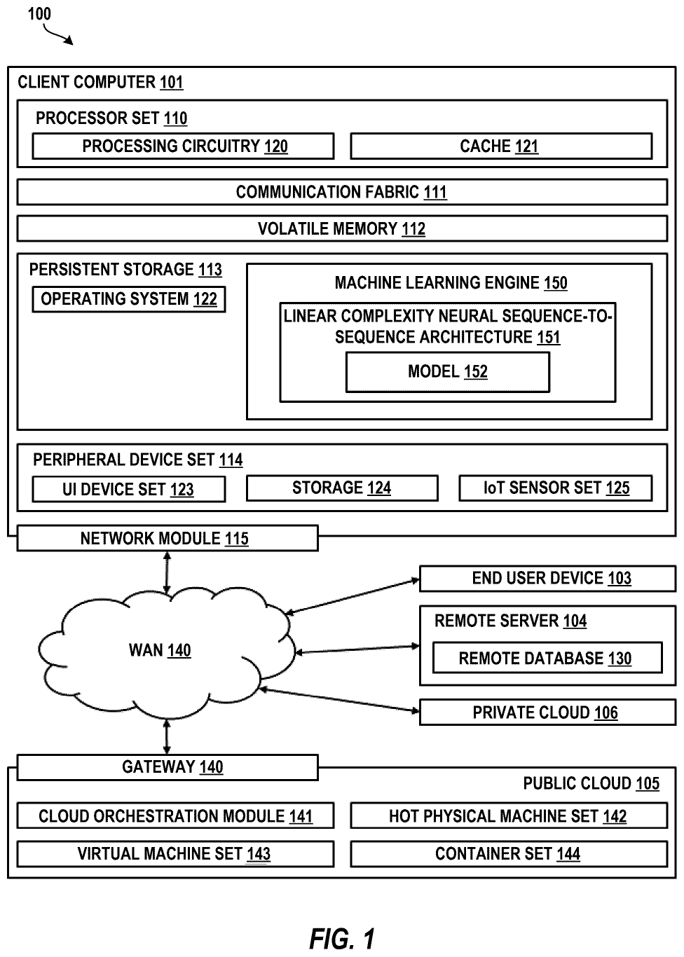

FIG. 1 illustrates a computing environment 100, according to an embodiment. Computing environment 100 contains an example of an environment for the execution of at least some of the computer code involved in performing the inventive methods, such as a machine learning engine 150, which may be used to train a model 152 using a linear complexity neural sequence-to-sequence architecture 151 and/or to perform inference using the model 152 based on the linear complexity neural sequence-to-sequence architecture 151. In addition to machine learning engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and machine learning engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in machine learning engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in machine learning engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks, such as speech recognition (e.g., generate a text transcript given an audio clip as input), sentiment classification (e.g., categorize opinions expressed in a piece of text), video activity recognition (e.g., identify an activity in a video clip), and/or the like. More specifically, one or more embodiments described herein can incorporate and utilize rule-based decision making and artificial intelligence (AI) reasoning to accomplish various tasks. The phrase “machine learning” broadly describes a function of electronic systems that learn from data. A machine learning system, engine, or module (e.g., the machine learning engine 150) can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used to perform various tasks. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

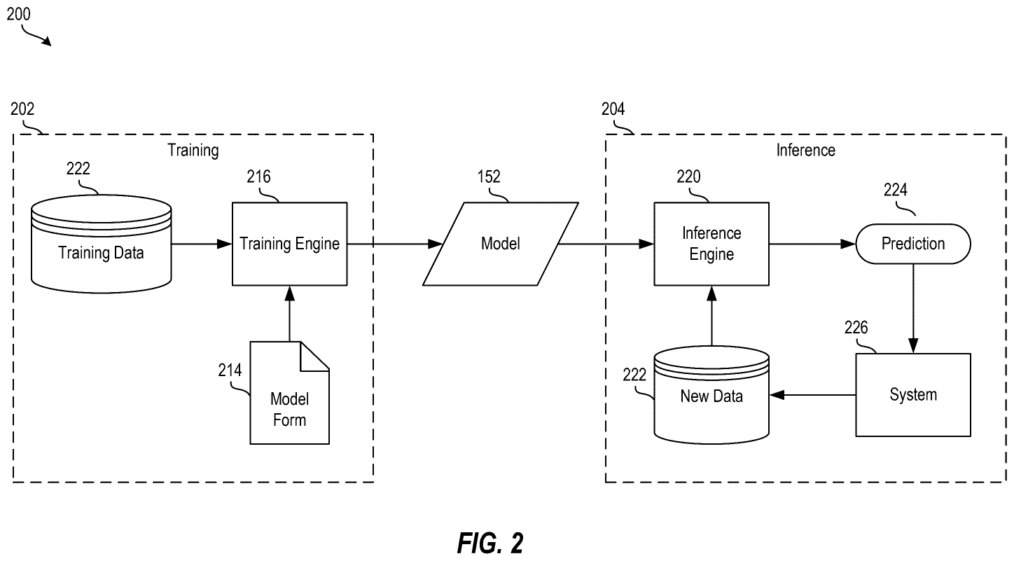

Systems for training and using a machine learning model are now described in more detail with reference to FIG. 2. Particularly, FIG. 2 depicts a block diagram of components of a machine learning training and inference system 200 according to one or more embodiments described herein. The machine learning training and inference system 200 performs training 202 and inference 204. According to one or more embodiments, the training 202 and/or the inference 204 utilizes the linear complexity neural sequence-to-sequence architecture 151 of the machine learning engine 150 of FIG. 1. During training 202, a training engine 216 trains a model (e.g., the model 152) to perform a task, such as to perform speech recognition (e.g., generate a text transcript given an audio clip as input), sentiment classification (e.g., categorize opinions expressed in a piece of text), video activity recognition (e.g., identify an activity in a video clip), and/or the like. Inference 204 is the process of implementing the model 152 to perform the task, such as to perform speech, sentiment classification, video activity recognition, and/or the like, in the context of a larger system (e.g., a system 226). All or a portion of the machine learning training and inference system 200 shown in FIG. 2 can be implemented, for example by all or a subset of the computing environment 100 of FIG. 1.

The training 202 begins with training data 212, which may be structured or unstructured data. According to one or more embodiments described herein, the training data 212 includes sequential data. Examples of sequential data include, but are not limited to, text streams, audio clips, video clips, time-series data, and/or the like. The training engine 216 receives the training data 212 and a model form 214. According to one or more embodiments described herein, the model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform image classification, the model form 214 may be a model form of a CNN, although other types of model forms and/or algorithms can be implemented.

According to one or more embodiments described herein, the model form 212 represents an algorithm that can be trained to perform a particular task. In some embodiments, the model form 214 is an algorithm that can include, for example, supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms. Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

According to one or more embodiments described herein, the model form 214 is a foundational model that is trained on a wide variety of generalized, unlabeled training data, which may be sequential data, to perform one or more different general tasks, such as generating content (text, images, etc.), performing natural language processing, and/or the like including combinations and/or multiples thereof. In the case of the model form 214 being a foundational model, the training 202 can include tuning the foundational model (e.g., the model form 214) using the training data 212. Tuning the foundational model provides the benefits of the broad capabilities of the foundational model while enabling the foundational model to be customized using training data (e.g., the training data 212) related to a particular task or environment to which the foundational modal is then applied. In this way, the training 202 need not train a new model from scratch, which is time-consuming and resource intensive.

The training 202 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 212 includes labeled images, including images of the object of interest with associated labels (ground truth) and other images that do not include the object of interest with associated labels. In this example, the training engine 216 takes as input a training image from the training data 212, makes a prediction for classifying the image, and compares the prediction to the known label. The training engine 216 then adjusts weights and/or biases of the model based on results of the comparison, such as by using backpropagation. The training 202 may be performed multiple times (referred to as “epochs”) until a suitable model is trained (e.g., the model 152).

Once trained, the model 152 can be used to perform inference 204 to perform a task, such as to perform speech, sentiment classification, video activity recognition, and/or the like. The inference engine 220 applies the model 152 to new data 222 (e.g., real-world, non-training data), which may be sequential data. For example, if the model 152 is trained to classify images of a particular object, such as a chair, the new data 222 can be an image of a chair that was not part of the training data 212. In this way, the new data 222 represents data to which the model 218 has not been exposed. The inference engine 220 makes a prediction 224 (e.g., a classification of an object in an image of the new data 222) and passes the prediction 224 to the system 226 (e.g., the computing environment 100 of FIG. 1). The system 226 can, based on the prediction 224, take an action, perform an operation, perform an analysis, and/or the like, including combinations and/or multiples thereof. In some embodiments, the system 226 can add to and/or modify the new data 222 based on the prediction 224.

In accordance with one or more embodiments, the predictions 224 generated by the inference engine 220 are periodically monitored and verified to ensure that the inference engine 220 is operating as expected. Based on the verification, additional training 202 may occur using the model 152 as the starting point. The additional training 202 may include all or a subset of the original training data 212 and/or new training data 212. In accordance with one or more embodiments, the training 202 includes updating the model 152 to account for changes in expected input data.

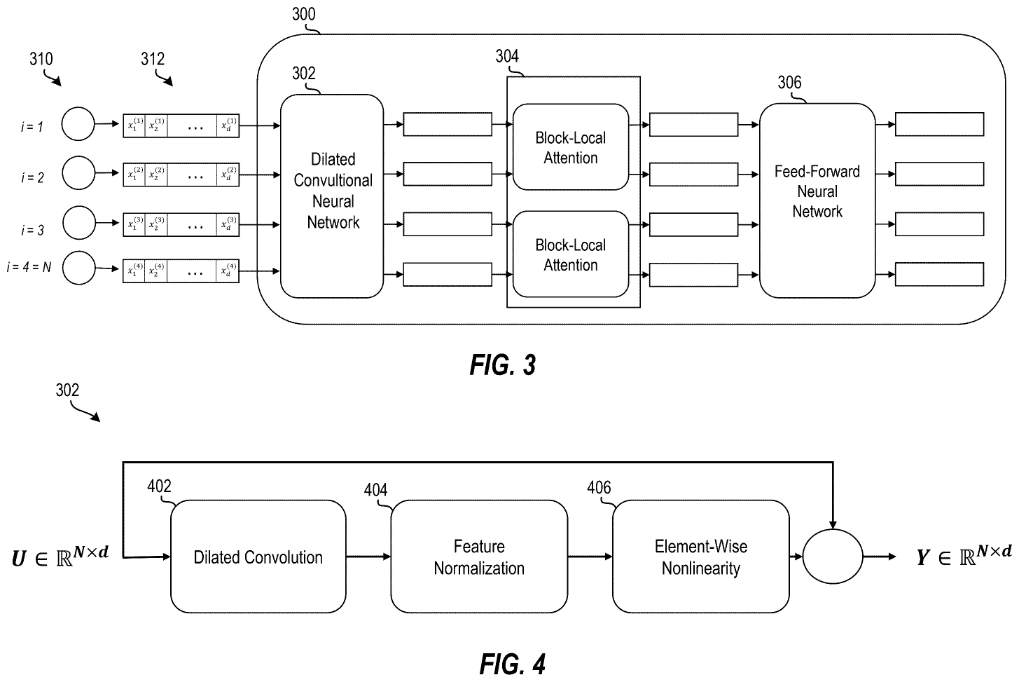

One or more embodiments are now described in more detail with reference to FIGS. 3-8. Such one or more embodiments provide a dilated convolution and attention-based neural network with linear complexity (O(N)). The dilated convolution and attention-based neural network (also referred to as a linear complexity neural sequence-to-sequence model) is applicable to a range of problems. According to one or more embodiments, the dilated convolution and attention-based neural network includes linear compute and memory complexity temporal processing units and linear compute and memory complexity feature processing units. The linear compute and memory complexity temporal processing units mix information across different time steps in the input sequence. The linear computational and memory complexity feature processing units process tokens at separate time steps within the sequence independently of one another.

According to one or more embodiments, the dilated convolution and attention-based neural network employes dilated convolutions to model long-range data dependencies in linear computational and memory cost. The one or more embodiments also makes use of chunked self-attention, which operates within fixed-size blocks in the sequence, maintaining the linear computational and memory complexity of the model.

One or more embodiments described herein, which implement the dilated convolution and attention-based neural network, achieves Pareto optimal results in accuracy and speed. The linear scaling law of the dilated convolution and attention-based neural network provides efficient and accurate computation with very long sequence lengths while maintaining the linear computational and memory complexity of the model.

FIG. 3 illustrates a block diagram of a dilated convolution and attention-based neural network 300, according to an embodiment. In this embodiment, the dilated convolution and attention-based neural network 300 includes a dilated CNN 302 followed by block-local attention blocks 304, and a feed-forward neural network 306. It should be appreciated that the dilated CNN 302 has a cost of O(N), the block-local attention blocks 304 have a cost of O(1), and the feed-forward neural network 306 has a cost of O(N) in terms of computational efficiency.

The dilated convolution and attention-based neural network 300 receives sequential data 310 as input. Examples of sequential data include, but are not limited to, text streams, audio clips, video clips, time-series data, and/or the like. Each of the circles in FIG. 3 represents a sequence element of the sequential data 310. The sequential data 310 can be expressed as a sequence of d-dimensional vector embeddings 312 (e.g., {x⁽¹⁾, . . . , x⁽⁴⁾}). For example, a first element (i=1) of the sequential data 310 can be expressed as d-dimensional vector embedding {x₁⁽¹⁾, x₂⁽¹⁾, . . . , x_{d}⁽¹⁾}. The value of “d” (as in the d-dimensional vector embeddings 312) represents a length of the sequence element. The d-dimensional vector embeddings 312 are fed into the dilated convolution and attention-based neural network 300.

The dilated convolution and attention-based neural network 300 receives the d-dimensional vector embeddings 312. As described herein and as shown in FIG. 3, the dilated convolution and attention-based neural network 300 includes a dilated CNN 302 followed by block-local attention blocks 304 and a feed-forward neural network 306.

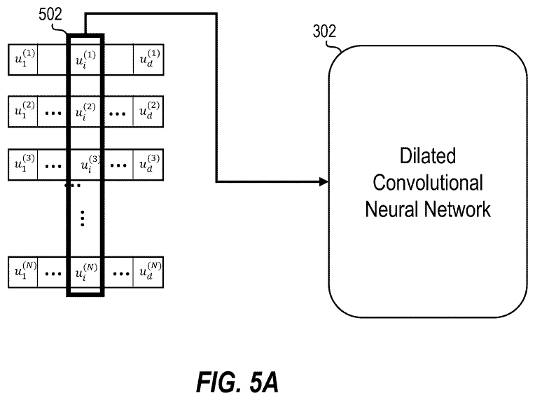

The dilated CNN 302 is shown in more detail in FIG. 4, and the features of the dilated CNN 302 are now described with reference to FIGS. 4-6; further aspects of FIG. 3 are subsequently described. In particular, as shown in FIG. 4, the dilated CNN 302 includes a dilated convolution block 402, a feature normalization block 404, and an element-wise nonlinearity block 406. According to one or more embodiments, the structure of the dilated CNN 302 is determined by its depth D, its dilation factor f, and a kernel size K. The dilated CNN 302 is implemented as a sequence of residual blocks, with each subsequent block having a higher dilation.

The dilated convolution block 402 receives as input sequence elements of the sequential data 310, which can be expressed as U∈ [symbol] ^{N×d}, where U is an embedded input, [symbol] is the set of real numbers, N is the length of the sequence, and d is the length of the sequence element. For a layer d∈{1, . . . , D}, the dilation is f^{d-1}. The convolution computation can be performed as described herein. For example, a dilated convolution of a one-dimensional sequence of length N (x∈ [symbol] ^{N}) with a kernel of size K (h∈ [symbol] ^{K}, assume K is odd), and dilation f∈ [symbol] results in an output sequence y∈ [symbol] ^{N-f×(k-1)}, where each element of the output (yᵢ∈ [symbol] ) is expressed as:

$${y}_{i} = {\sum }_{k = 1}^{K} {h}_{k} \times {x}_{i + ( k - \frac{K - 1}{2} ) \times f} .$$

The output of the dilated convolution block 402 is fed into the feature normalization block 404, normalizes activations along a feature direction (rather than in a mini-batch direction) and thus normalizes each feature of the activations to a zero mean and unit variance. For example, the feature normalization block 404 can directly estimate the normalization statistics from summed inputs to the neurons within a hidden layer.

The output of the feature normalization block 404 is fed into the element-wise nonlinearity block 406, which applies a nonlinear activation function (e.g., rectified linear unit (ReLU) activation function, sigmoid linear unit (SiLU) activation function, hyperbolic tangent (tanh) activation function, and/or the like, including combinations and/or multiples thereof) to generate the output of the dilated CNN 302, which can be expressed as Y∈ [symbol] ^{N×d}, as shown.

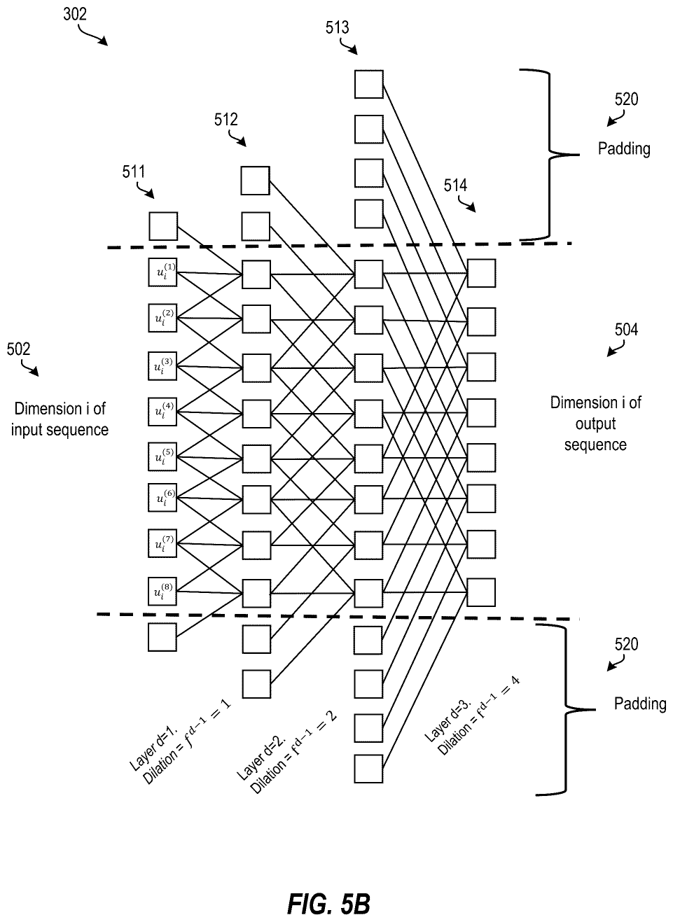

The dilated CNN 302 operates on each dimension of the input embedding sequence (e.g., the d-dimensional vector embeddings 312 of the sequential data 310) independently. According to one or more embodiments, the dilated CNN 302 includes L layers, which sequentially process a 1-dimensional input sequence. The dilated CNN 302 is characterized by the number of layers (depth) D, the convolutional kernel size K, and the dilation factor f. Each layer l in the dilated CNN 302 is a dilated convolutional operator with dilation f^{l-1}. As shown in FIG. 5A, the dilated CNN 302 receives a sequence of N-many d-dimensional vector embeddings {u⁽¹⁾, . . . , u^{(N)}}. Each dimension 1≤i≤d of the input sequence is processed by an independent dilated CNN 302, according to one or more embodiments. FIG. 5B depicts a dilated CNN 302 having depth D=3, convolutional kernel size K=3, and a dilation factor f=2. In the example of FIG. 5B, the dilated CNN 302 receives a dimension i of the input sequence (e.g., the input 502 of FIG. 5A) at an input layer 511 (e.g., a first layer) of the dilated CNN 302. The input layer 511 is fully connected to a second layer 512 of the dilated CNN 302 as shown. The second layer 512, also referred to as layer d=1, has a dilation factor of f^{d-1}=1. The second layer 512 is connected to a third layer 513 of the dilated CNN 302 as shown. The third layer 513, also referred to as layer d=2, has a dilation factor of f^{d-1}=2. The third layer 513 is connected to a fourth layer 514 of the dilated CNN 302 as shown. The fourth layer 514, also referred as layer d=3 or the output layer, has a dilation factor of f^{d-1}=4. The fourth layer 514 generates a dimension i of the output sequence (e.g., output 504). It should be appreciated that padding 520 can be added to the input layer 511, the second layer 512, and/or the third layer 513 in order for the output 504 to be of the same length as the input 502.

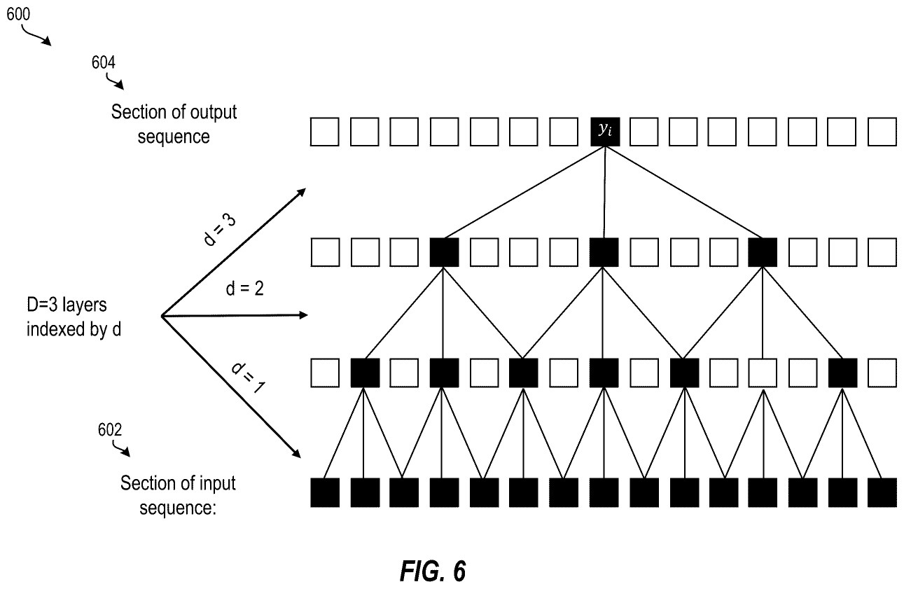

Turning now to FIG. 6, an example of a network connectivity layout 600 of the dilated CNN 302 is shown according to one or more embodiments. In this example, for each element yᵢ of the output 604 of the dilated CNN 302, the receptive field size measures the distance between the first and the last element in the input sequence 602, which influences the computation of yᵢ. For a network with dilation factor f, odd kernel size k, and depth D, the receptive field size can be computed using the following equation:

$$1 + {\sum }_{d = 1}^{D} {f}^{d - 1} \times \frac{k - 1}{2} \times 2.$$

According to one or more embodiments, not all combinations of k, f, and D are dense over the input sequence. In this case, “dense” refers to there being no blind spots in the receptive field. The condition for no blind spots is f<k+1.

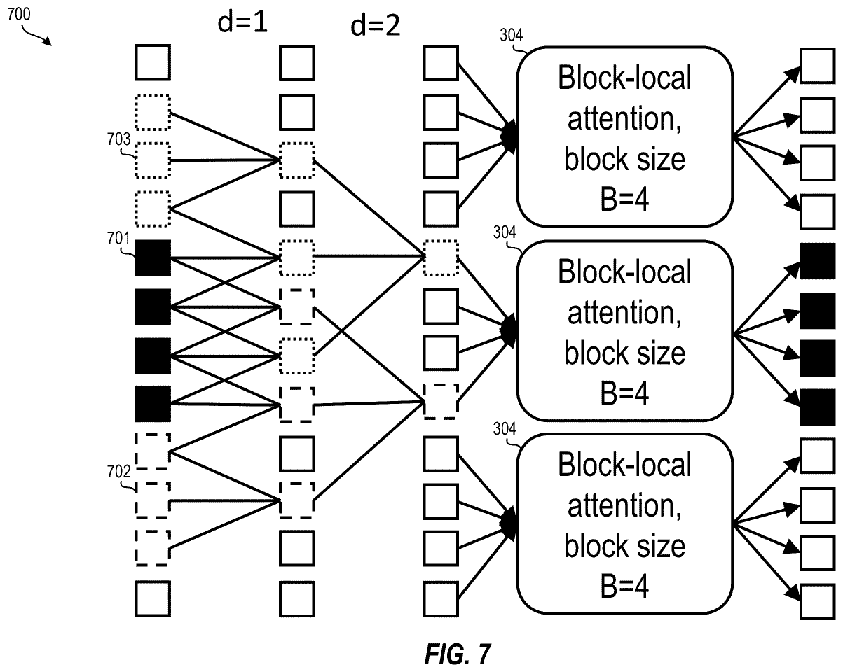

Returning now to the discussion of FIG. 3, the output of the dilated CNN 302 is fed into one of the block-local attention blocks 304, which are now described in more detail with reference to FIG. 7. In particular, FIG. 7 depicts network connectivity 700 for block-local attention blocks 304, according to one or more embodiments. The block-local attention blocks 304 take as input the output of the dilated CNN 302 and generate as output local-gated-attention-modified sequence of vectors. The block-local attention blocks 304 influence the receptive field size of each block of the network. This effect is illustrated in FIG. 7. The combination of the dilated CNN 302 and the block-local attention blocks 304 leads to a wider receptive field (without a blind spot) that cannot be achieved by solely using dilated CNN at the given depth.

For example, consider one sequence processing block. The dilated CNN 302 is characterized by depth D=2. The output of the d-th convolutional layer is denoted as h_{d}. Consider the black squares (701) on the input (e.g., left) side and dashed squares (702) at depth d=2. An upper square can be denoted as

$${h}_{3}^{up}$$

and a lower square denoted as

$${h}_{3}^{down} .$$

For all d<3, the dotted squares (703) represent values that only influence the computation of the upper square

$${h}_{3}^{up}$$

and the dashed squares are those that influence the computation of the lower square

$${h}_{3}^{down} .$$

The black squares (701) on the input side in the input sequence influence both the upper square

$${h}_{3}^{up}$$

and the lower square

$${h}_{3}^{down} .$$

The attention operator of the block-local attention blocks 304 mixes up elements in its input sequence. As a result, the output tokens of the attention operator of the block-local attention blocks 304 depends on the entire input to the operator. Each black square (704) on the output (e.g., right) side represents an output token that depends on the black squares (701) on the input side, the dashed squares (702), and the dotted squares (703) (e.g., input tokens). This results in an expansion of the receptive field size of the block-local attention blocks 304. Given an attention block size B, the receptive field size of the output after attention is expressed as follows:

$$B + {\sum }_{d = 1}^{D} {f}^{d - 1} \times \frac{k - 1}{2} \times 2.$$

With continued reference to FIG. 3, once the block-local attention blocks 304 generate the local-gated-attention-modified sequence of vectors as output, that output is fed into the feed-forward neural network 306, which generates a sequence of vector embeddings, also referred to as a feed-forward network-modified sequence of vectors. Particularly, the feed-forward neural network 306 is a linear complexity feed-forward neural network that applies a transformation on each sequence element from the block-local attention blocks 304 independently.

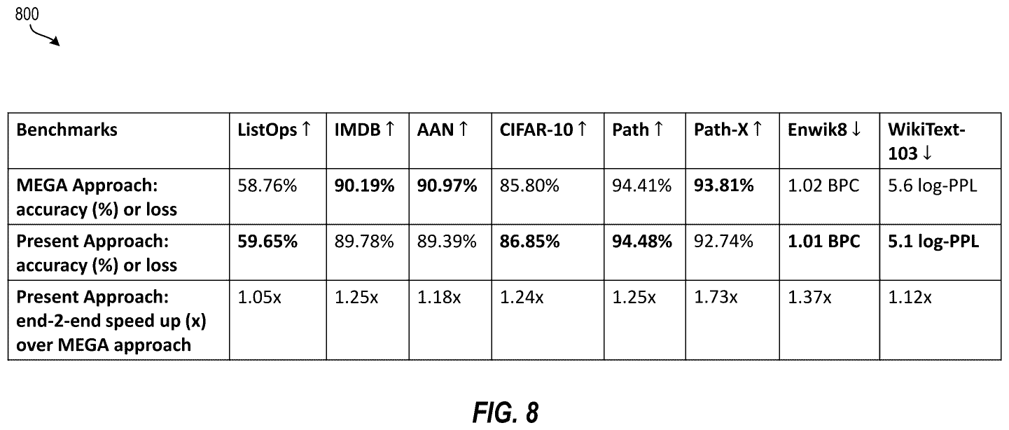

FIG. 8 illustrates a table 800 of results of using a dilated convolution and attention-based neural network, according to one or more embodiments. The table 800 shows that using a dilated convolution and attention-based neural network, as described according to one or more embodiments, scores competitively or better than existing sequential modeling approaches, including the MEGA approach, for long-range-arena classification tasks. Additionally, the table 800 shows that using a dilated convolution and attention-based neural network, as described according to one or more embodiments, is highly performant or even better on next-token-prediction language modeling tasks (e.g., Enwik8 and WikiText-103). For example, one or more embodiments provides 1.05×-1.73× end-to-end inference performance improvement compared to existing sequential modeling approaches.

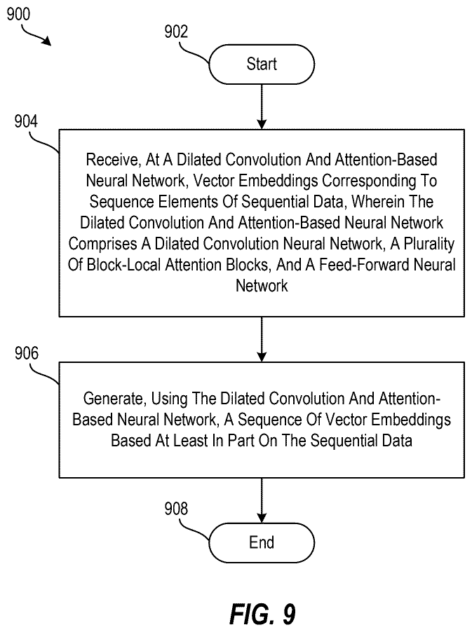

Turning now to FIG. 9, a flow diagram of a method 900 for generating a sequence of vector embeddings based on sequential data using a dilated convolution and attention-based neural network is provided, according to an embodiment. The method 900 can be performed by any suitable computing system, device, or environment, such as those described herein. For example, the method 900 can be performed by the machine learning training and inference system 200 shown in FIG. 2. According to one or more embodiments, the method 900 is performed using the linear complexity neural sequence-to-sequence architecture 151 of the machine learning engine 150 of FIG. 1.

The method 900 begins at block 902. At block 904, the dilated convolution and attention-based neural network 300 receives vector embeddings corresponding to sequence elements of sequential data. The dilated convolution and attention-based neural network 300 includes the dilated CNN 302, the block-local attention blocks 304, and the feed-forward neural network 306, configured and arranged as shown in FIG. 3, for example.

At block 906, the dilated convolution and attention-based neural network 300 generates a sequence of vector embeddings based at least in part on the sequential data.

According to one or more embodiments, generating the sequence of vector embeddings includes performing, for each sequence element of the sequence elements of sequential data the following operations. First, the dilated CNN 302 performs a convolutional computation to generate a first result as described herein. According to one or more embodiments, performing the convolutional computation includes performing a dilated convolution of a one-dimensional sequence of length N (x∈ [symbol] ^{N}) with a kernel of size K (h∈ [symbol] ^{K}, where K is odd), and dilation f∈ [symbol] to generate an output sequence y∈ [symbol] ^{N-f×(k-1)}. According to one or more embodiments, where each element of the output (yᵢ∈ [symbol] ) is expressed as:

$${y}_{i} = {\sum }_{k = 1}^{K} {h}_{k} \times {x}_{i + ( k - \frac{K - 1}{2} ) \times f} .$$

Next, the dilated CNN 302 performs activation normalization to the first result to generate a second result. Finally, the dilated CNN 302 applies a nonlinear activation function (e.g., ReLU, SiLU, tanh, etc.) to the second result to generate a third result. The third result is input to the block-local attention blocks 304.

According to one or more embodiments, the method 900 further includes receiving, at one of the plurality of block-local attention blocks 304, the third result from the dilated CNN 302 and generating, using the block-local attention blocks 304, local-gated-attention-modified sequence of vectors based at least in part on the third result (e.g., the result from the element-wise nonlinearity block 406).

According to one or more embodiments, the method 900 further includes generating, using the feed-forward neural network 306, a sequence of vector embeddings based at least in part on the local-gated-attention-modified sequence of vectors generated by each of the block-local attention blocks 304.

Once the dilated convolution and attention-based neural network 300 generates the sequence of vector embeddings at block 906, the method 900 proceeds to block 908 and terminates. According to one or more embodiments, the method 900 can repeat one or more times for additional sequential data.

Additional processes also may be included, and it should be understood that the processes depicted in FIG. 9 represent illustrations, and that other processes may be added or existing processes may be removed, modified, or rearranged without departing from the scope of the present disclosure. It should also be understood that the processes depicted in FIG. 9 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
receiving, at a dilated convolution and attention-based neural network, vector embeddings corresponding to sequence elements of sequential data, wherein the dilated convolution and attention-based neural network comprises a dilated convolutional neural network, a plurality of block-local attention blocks, and a feed-forward neural network; and
generating, using the dilated convolution and attention-based neural network, a sequence of vector embeddings based at least in part on the sequential data.

2. The computer-implemented method of claim 1, wherein generating the sequence of vector embeddings further comprises performing, for each sequence element of the sequence elements of sequential data:
performing, by the dilated convolutional neural network, a convolutional computation to generate a first result;
performing, by the dilated convolutional neural network, activation normalization to the first result to generate a second result; and
applying, by the dilated convolutional neural network, a nonlinear activation function to the second result to generate a third result, the third result being input to at least one of the plurality of block-local attention blocks.

3. The computer-implemented method of claim 2, wherein performing the convolutional computation comprises performing a dilated convolution of a one-dimensional sequence of length N (x∈ [symbol] ^{N}) with a kernel of size K (h∈ [symbol] ^{K}, where K is odd), and dilation f∈ [symbol] to generate an output sequence y∈ [symbol] ^{N-f×(k-1)}.

4. The computer-implemented method of claim 3, where each element of the output (yᵢ∈ [symbol] ) is expressed as:
$${y}_{i} = {\sum }_{k = 1}^{K} {h}_{k} \times {x}_{i + ( k - \frac{K - 1}{2} ) \times f} .$$

5. The computer-implemented method of claim 2, further comprising, for each third result:
receiving, at one of the plurality of block-local attention blocks, the third result from the dilated convolutional neural network; and
generating, using the one of the plurality of block-local attention blocks, local-gated-attention-modified sequence of vectors based at least in part on the third result.

6. The computer-implemented method of claim 5, further comprising generating, using the feed-forward neural network, the sequence of vector embeddings based at least in part on the local-gated-attention-modified sequence of vectors generated by each of the plurality of block-local attention blocks.

7. The computer-implemented method of claim 2, wherein the nonlinear activation function is a rectified linear unit activation function, a sigmoid linear unit activation function, or a hyperbolic tangent activation function.

8. The computer-implemented method of claim 1, wherein the sequential data comprises a text stream, an audio clip, a video clip, or time-series data.

9. A system comprising:
a memory comprising computer readable instructions; and
a processing device for executing the computer readable instructions, the computer readable instructions controlling the processing device to perform operations comprising:
receiving, at a dilated convolution and attention-based neural network, vector embeddings corresponding to sequence elements of sequential data, wherein the dilated convolution and attention-based neural network comprises a dilated convolutional neural network, a plurality of block-local attention blocks, and a feed-forward neural network; and
generating, using the dilated convolution and attention-based neural network, a sequence of vector embeddings based at least in part on the sequential data.

10. The system of claim 9, wherein generating the sequence of vector embeddings further comprises performing, for each sequence element of the sequence elements of sequential data:
performing, by the dilated convolutional neural network, a convolutional computation to generate a first result;
performing, by the dilated convolutional neural network, activation normalization to the first result to generate a second result; and
applying, by the dilated convolutional neural network, a nonlinear activation function to the second result to generate a third result, the third result being input to at least one of the plurality of block-local attention blocks.

11. The system of claim 10, wherein performing the convolutional computation comprises performing a dilated convolution of a one-dimensional sequence of length N (x∈ [symbol] ^{N}) with a kernel of size K (h∈ [symbol] ^{K}, where K is odd), and dilation f∈ [symbol] to generate an output sequence y∈ [symbol] ^{N-f×(k-1)}.

12. The system of claim 11, where each element of the output (yᵢ∈ [symbol] ) is expressed as:
$${y}_{i} = {\sum }_{k = 1}^{K} {h}_{k} \times {x}_{i + ( k - \frac{K - 1}{2} ) \times f} .$$

13. The system of claim 10, wherein the operations further comprise, for each third result:
receiving, at one of the plurality of block-local attention blocks, the third result from the dilated convolutional neural network; and
generating, using the one of the plurality of block-local attention blocks, local-gated-attention-modified sequence of vectors based at least in part on the third result.

14. The system of claim 13, wherein the operations further comprise generating, using the feed-forward neural network, the sequence of vector embeddings based at least in part on the local-gated-attention-modified sequence of vectors generated by each of the plurality of block-local attention blocks.

15. The system of claim 10, wherein the nonlinear activation function is a rectified linear unit activation function, a sigmoid linear unit activation function, or a hyperbolic tangent activation function.

16. The system of claim 9, wherein the sequential data comprises a text stream, an audio clip, a video clip, or time-series data.

17. A computer program product comprising:
a set of one or more computer-readable storage media;
program instructions, collectively stored in the set of one or more storage media, for causing a processor set to perform the following computer operations:
receiving, at a dilated convolution and attention-based neural network, vector embeddings corresponding to sequence elements of sequential data, wherein the dilated convolution and attention-based neural network comprises a dilated convolutional neural network, a plurality of block-local attention blocks, and a feed-forward neural network; and
generating, using the dilated convolution and attention-based neural network, a sequence of vector embeddings based at least in part on the sequential data.

18. The computer program product of claim 17, wherein generating the sequence of vector embeddings further comprises performing, for each sequence element of the sequence elements of sequential data:
performing, by the dilated convolutional neural network, a convolutional computation to generate a first result;
performing, by the dilated convolutional neural network, activation normalization to the first result to generate a second result; and
applying, by the dilated convolutional neural network, a nonlinear activation function to the second result to generate a third result, the third result being input to at least one of the plurality of block-local attention blocks.

19. The computer program product of claim 18, wherein performing the convolutional computation comprises performing a dilated convolution of a one-dimensional sequence of length N (x∈ [symbol] ^{N}) with a kernel of size K (h∈ [symbol] ^{K}, where K is odd), and dilation f∈ [symbol] to generate an output sequence y∈ [symbol] ^{N-f×(k-1)}.

20. The computer program product of claim 19, where each element of the output (yᵢ∈ [symbol] ) is expressed as:
$${y}_{i} = {\sum }_{k = 1}^{K} {h}_{k} \times {x}_{i + ( k - \frac{K - 1}{2} ) \times f} .$$
